(19) United States
(12) Patent Application Publication
(10) Pub. No.: US 2020/0308514 A1
(43) Pub. Date: Oct. 1, 2020

(54) Soap shape to prevent dropping

(71) Applicants: Timothy Patrick Corley, Fredericksburg, VA (US); Jack Corley, Heimdel, NJ (US); Kevin Joseph Corley, Ridgefield, CT (US)

(72) Inventors: Timothy Patrick Corley, Fredericksburg, VA (US); Jack Corley, Heimdel, NJ (US); Kevin Joseph Corley, Ridgefield, CT (US)

(21) Appl. No.: 16/590,576

(22) Filed: Oct. 2, 2019

Related U.S. Application Data
(60) Provisional application No. 62/739,889, filed on Oct. 2, 2018.

(51) Int. Cl. C11D 17/00; C11D 13/14

(52) U.S. Cl. CPC C11D 17/0047; C11D 13/14

(57) ABSTRACT

A bar of soap is made so as to be more easily held without slipping by providing one or more finger-width slots along a side of the bar of soap.

### TECHNICAL FIELD

The present invention relates to personal cleansing products, and more specifically to soaps and soap like products for use in a bath or shower.

### BACKGROUND INFORMATION

Soap is almost as old as civilization. From the oldest formulation of lye and fat, soap has progressed to scented versions, soap with inclusions for aesthetic effect or for extra scrubbing power (such as sand or grit). Soap can be molded into an innumerable assortment of shapes for amusement or for marketing purposes.

One problem remains: the user may drop the soap in a shower, or lose the soap while in a bathtub. Bending over to pick up the soap can be dangerous, especially to the elderly. Indeed, even a young fit man can slip and injure himself as did astronaut John Glenn in 1964, slipping and hitting his head on the tub sustaining a concussion and affecting his inner ear. Glenn suffered from persistent symptoms of nausea, dizziness and tinnitus. The risk of slipping on the shower floor to retrieve a dropped bar of soap is not inconsequential.

A recent study (Jul. 10, 2011) by the Centers for Disease Control and Prevention found that two-thirds of all accidental injuries in the bathroom happen in the tub or shower. Shower and bath falls are particularly hazardous for the elderly, with brittle bones often resulting in fractured hips.

What is needed is a way to render soap less susceptible to being dropped, while not interfering with its basic function of washing.

### BRIEF SUMMARY OF THE INVENTION

The present invention addresses the problem of a bar of soap slipping from a user's hand by providing one or more finger width indentations or slots molded or milled to include such indentations along one side of the bar of soap, so that by placing the bar between the thumb and fingers, inserting one or more fingers in the slots on the opposing side from the thumb the bar of soap may be securely held.

### BRIEF DESCRIPTION OF THE DRAWINGS

FIG. 1 shows several but not all possible soap bar shapes suitable for use with the present invention.

FIG. 2 shows a soap on a rope from the prior art, one attempt to address the problems to which the present invention is directed.

FIG. 3 is a top down view of a rectangular bar of soap with finger grips showing one embodiment of the present invention.

FIG. 4 is an oblique view of a generally rectangular prism shaped bar of soap having one curved side, with finger grips showing yet another embodiment of the present invention.

FIG. 5 is a top down view of a generally rectangular bar of soap with yet another embodiment of the present invention. having inwardly slanted sides to the finger grips.

### BRIEF DESCRIPTION OF THE INVENTION

Decorative shapes, such as molded soaps on the form of scallop shells or hearts are pretty, ubiquitous and well known in the art, but do little or nothing to provide a secure surface for gripping the wet bar of soap.

One attempted solution to the problem of dropping soap has been to embed a rope in the bar of soap, or to place a hole in the soap through which a rope may be inserted. See FIG. 2. An ovoid bar of soap 12, has within it a loop of rope 10 through which a hand may be inserted to prevent loss of the bar in the event it slips from the hand. However, the rope is objectionable to some, and inconvenient for lathering up. The rope can retain dirt, and in time become odorous.

The present invention addresses the problem of a bar of soap slipping within a user's hand by providing one or more finger grips on the bar, comprising one or more finger width slots in the bar of soap.

### DETAILED DESCRIPTION OF THE INVENTION

For purposes of this disclosure, “soap” is defined as any solid bodily cleansing confection including but not limited to as lye or similar saponifying agent and fat or oil-based soaps, cleansing cream soaps, soaps with fragrance, exfoliant soaps and soaps with abrasives included to aid in scrubbing.

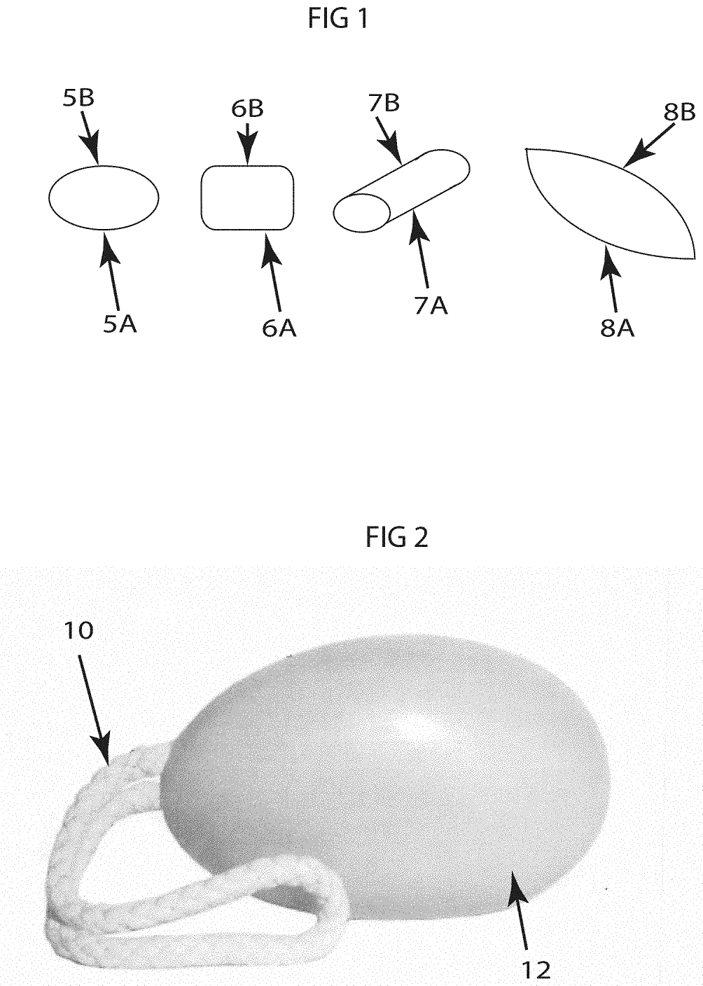

A bar of soap is defined as a quantity of soap in amount and shape as to be easily held within a user's hand. It may be any of a variety of shapes readily gripped in a hand. By way of example, but not intended as an exhaustive list of possible bar shapes, is shown in FIG. 1. And ovoid bar is shown with a first side 5A and an opposing side 5B. A rectilinear shape is shown with a first side 6A, and an opposing side 6B. A cylindrical bar is shown with a first side 7A, and an opposing side 7B. A roughly banana shaped bar is shown with a first side 8A and an opposing side 8B. It will be apparent o one skilled in the art that there are a variety of additional shapes from which a bar of soap may be made applicable for use with the present invention. Of importance is that the shape of the bar has a first side into which the slots of the present invention may be formed, and a second side which in use may be held by the thumb, and/or palm with one or more fingers in slots on the first side holding the bar in opposition to the thumb.

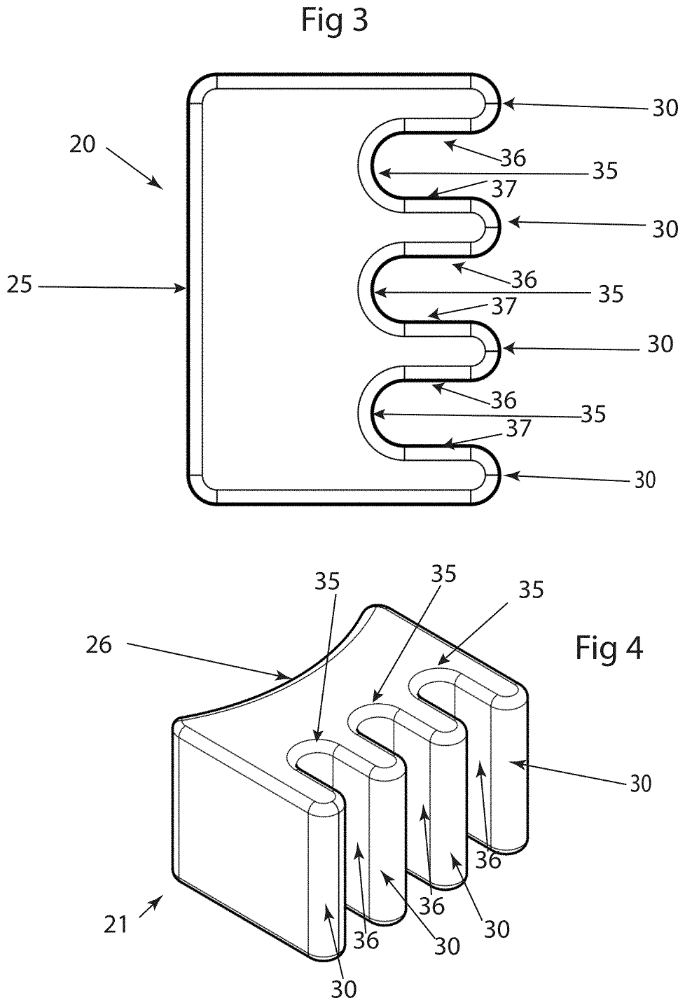

The present invention addresses the problems discussed above. A bar of soap may be molded or milled to include one or more slots to provide finger gripping shapes. One embodiment of the present invention as shown in FIG. 3 A bar of soap 20 has three such finger grips, each comprising a slot having a first side 36, a second side 37 and a bottom 35. While the bottom 35 is shown as rounded, it may also be flat.

The slots are separated from the sides of the bar of soap 20 and one another by interstitial members 30. The bar of soap 20 may be securely held with the palm and thumb against a side 25, and placing a user's three fingers in the finger grip slots. such that the three middle fingers may grasp the bar at and securely hold the bar of soap.

The indentations are shaped to allow each individual user to create his own distinct hold onto the bar. The thumb and palm will create their own cohesiveness to the product over time, keeping it safely in the hands of the user. The indentations allow gripping the bar in such a way as to make the product mold in use and become more effective with time for an individual user.

The finger grips may be on one or more sides of the soap, or on a curved side of the soap within the scope if the present invention. It is preferential, however, to have the indentations on a single side so as not to reduce the soap content of the bar unnecessarily. It is also important the finger grips be placed on one side of the bar of soap which is in opposition to a second side so that the user's fingers within the finger grips may hold the bar against the palm.

Decorative moldings may be included on one or more sides of the bar without interfering with the added gripping surfaces provided by the present invention.

It is important to make the size of the indentations such that they remain as the soap is used. The greatest wear should be on the un-indented portion of the bar so that as the soap is used, the indentations remain to facilitate secure gripping.

Finger grips should ideally have in interstitial width of soap 30 between the finger grips and between the sides of the bar of soap and between each finger grip. This interstitial width should ideally be at least ¼ inch.

While the sides of the finger grips 36 and 37 are shown as parallel, they may also be inclined inwardly at an angle between zero and 30 degrees. toward the bottom 35. The slots comprising the finger grips should be at an angle relatively normal to the opposite side of the bar of soap 25 from the side in which the finger grips appear.

FIG. 4 shows another bar of soap 21 having finger grips but a curved opposite side 26. It will be apparent to one skilled in the art that such a change from FIG. 3 does not alter the gripping characteristics of the bar of soap with finger grips, nor would altering the shape of the bar of soap to other grabable shapes be incompatible with the present invention.

1. A bar of soap, comprising at least one finger grip, said finger grip comprising a finger width slot indented into said bar to a depth, said depth being at least ¼ inch.

2. The bar of soap in claim 1, comprising a plurality of finger grips separated by interstitial members.

3. The bar of soap in claim 2 wherein the bottoms of said finger grips are curved.

4. The bar of soap in claim 2 wherein the bottoms of said finger grips are flat.

5. The bar of soap in claim 2 wherein the sides of said finger grips are angled inwardly between 0 degrees and 30 degrees.

6. The bar of soap in claim 2 wherein said interstitial members are at least ⅜ inch wide.

7. A bar of soap comprising a shape selected form the group consisting of a rectangular prism, ovoid, cylinder, and banana shaped; said bar having a plurality of finger grips along one side of said bar, each comprising a finger width slot indented into said bar to a depth of at least ¼ inch.
